(19) United States
(12) Patent Application Publication
(10) Pub. No.: US 2025/0241343 A1
(43) Pub. Date: Jul. 31, 2025

(54) AN INSTANT PORRIDGE COMPOSITION

(71) Applicant: SOCIETE DES PRODUITS NESTLE S.A., Vevey (CH)

(72) Inventors: ALOK KUMAR SINGH, Uttar Pradesh (IN); ROHIT UPADHYAY, Haryana (IN); JOYDEEP RAY, Haryana (IN); MANVI BERIWAL, Gurgaon (IN)

(21) Appl. No.: 18/854,230

(22) PCT Filed: Apr. 4, 2023
(86) PCT No.: PCT/EP2023/058746

§ 371 Date: Oct. 4, 2024

(30) Foreign Application Priority Data
Apr. 6, 2022 (IN) 202211020698
May 24, 2022 (EP) 22175028.4

(51) Int. Cl. A23L 7/143

(52) U.S. Cl. CPC A23L 7/143

(57) ABSTRACT

The present invention relates to an instant porridge composition comprising grain flake, lipid, flour and flavor, wherein the grain flake has a thickness between 0.3 to 1 mm.

The present invention relates to an instant porridge composition comprising grain flake, lipid, flour and flavor, wherein the grain flake has a thickness between 0.3 to 1 mm.

It is already known to have porridges will be cooked for 10 to 15 min to get a required texture and taste. Instant porridges have the advantage that the preparation time is shorten to 4 to 5 min by adding hot water/milk, but the texture is pasty.

Therefore, in order to provide an instant porridge, it should hydrate and swell properly without being completely pasty after 4 minutes by adding hot water or hot milk. In addition, the porridge has a nutritional benefit being a source of protein and fiber. A shelf-life of at least 6 months of the product should be achieved.

### SUMMARY OF THE INVENTION

The object of the present invention is to improve the state of the art and to provide an improved or at least an alternative solution to overcome at least some of the inconveniences described above. The object of the present invention is achieved by the subject matter of the independent claims. The dependent claims further develop the idea of the present invention.

Particularly, the object of the present invention is to provide an instant porridge composition having a soaking time of 4 min when hot water or hot milk is added. It has a fast hydration time and quick dispersibility to give a right texture with still visible flakes and a mouthfeel which is soft and not pasty. The shelf-life of at least 6 months of the product can be achieved.

Accordingly, the present invention provides in a first aspect an instant porridge composition comprising grain flake, lipid, flour and flavor, wherein the grain flake has a thickness between 0.3 to 1 mm.

It has been surprisingly found by the inventors that an instant porridge composition using grain flake having a thickness between 0.3 to 1 mm are well hydrated and swell properly without being completely pasty within 4 minutes after adding hot water/milk. In addition, the composition has a nutritional effect being a source of protein and fiber

### DETAILED DESCRIPTION OF THE INVENTION

In a first aspect the present invention pertains an instant porridge composition comprising grain flake, lipid, flour and flavor, wherein the grain flake has a thickness between 0.3 to 1 mm

In a preferred aspect the present invention pertains to an instant porridge composition comprising grain flake, lipid, flour and flavor, wherein the grain flake has a thickness between 0.3 to 1 mm and a length between 2.5 to 15 mm.

In a preferred aspect the present invention pertains to an instant porridge composition comprising grain flake, lipid, flour and flavor, wherein the grain flake has a thickness between 0.3 to 1 mm and a length between 2.5 to 15 mm and wherein the grain flake is selected from the group consisting of wheat flake, barley flake, oat flake, maize flake, rye flake, millet flake or a combination thereof.

In a preferred aspect the present invention pertains to an instant porridge composition comprising 15 to 70 wt % grain flake (based on the total composition), 2 to 20 wt % lipid (based on the total composition), 6 to 50 wt % flour (based on the total composition) and 0.5 to 45 wt % flavor (based on the total composition), wherein the grain flake has a thickness between 0.3 to 1 mm and a length between 2.5 to 15 mm.

In a preferred aspect the present invention pertains to an instant porridge composition comprising 15 to 60 wt % grain flake (based on the total composition), 2 to 20 wt % lipid (based on the total composition), 6 to 50 wt % flour (based on the total composition) and 0.5 to 45 wt % flavor (based on the total composition), wherein the grain flake has a thickness between 0.3 to 1 mm and a length between 2.5 to 15 mm.

In a preferred aspect the present invention pertains to an instant porridge composition comprising millet flake, barley flake, lipid, flour and flavor, wherein the millet flake and barley flake have a thickness between 0.3 to 1 mm.

In a preferred aspect the present invention pertains to an instant porridge composition comprising pearl millet flake, barley flake, lipid, flour and flavor, wherein the pearl millet flake and barley flake have a thickness between 0.3 to 1 mm.

In a preferred aspect the present invention pertains to an instant porridge composition comprising millet flake, barley flake, lipid, flour and flavor, wherein the millet flake and barley flake have a thickness between 0.3 to 1 mm and a length between 2.5 to 15 mm.

In a preferred aspect the present invention pertains to an instant porridge composition comprising pearl millet flake, barley flake, lipid, flour and flavor, wherein the pearl millet flake and barley flake have a thickness between 0.3 to 1 mm and a length between 2.5 to 15 mm.

In a preferred aspect the present invention pertains to an instant porridge composition comprising bajra flake, barley flake, lipid, flour and flavor, wherein the bajra flake and barley flake have a thickness between 0.3 to 1 mm and a length between 2.5 to 15 mm.

In a preferred aspect the present invention pertains to an instant porridge composition comprising 15 to 45 wt % pearl millet flake (based on the total composition), 8 to 30 wt % barley flake (based on the total composition), 2 to 20 wt % lipid (based on the total composition), 6 to 50 wt % flour (based on the total composition) and 0.5 to 45 wt % flavor (based on the total composition), wherein the pearl millet flake and barley flake have a thickness between 0.3 to 1 mm and a length between 2.5 to 15 mm.

In a preferred aspect the present invention pertains to an instant porridge composition comprising 15 to 45 wt % bajra flake (based on the total composition), 8 to 30 wt % barley flake (based on the total composition), 2 to 20 wt % lipid (based on the total composition), 6 to 50 wt % flour (based on the total composition) and 0.5 to 45 wt % flavor (based on the total composition), wherein the bajra flake and barley flake have a thickness between 0.3 to 1 mm and a length between 2.5 to 15 mm.

In a preferred aspect the present invention pertains to an instant porridge composition comprising millet flake, barley flake, lipid, wheat flour, pulse flour and flavor, wherein the millet flake and barley flake have a thickness between 0.3 to 1 mm and a length between 2.5 to 15 mm.

In a preferred aspect the present invention pertains to an instant porridge composition comprising pearl millet flake, barley flake, lipid, wheat flour, pulse flour and flavor, wherein the pearl millet flake and barley flake have a thickness between 0.3 to 1 mm and a length between 2.5 to 15 mm.

In a preferred aspect the present invention pertains to an instant porridge composition comprising bajra flake, barley flake, lipid, wheat flour, pulse flour and flavor, wherein the bajra flake and barley flake have a thickness between 0.3 to 1 mm and a length between 2.5 to 15 mm.

In a preferred aspect the present invention pertains to an instant porridge composition comprising 15 to 45 wt % pearl millet flake (based on the total composition), 8 to 30 wt % barley flake (based on the total composition), 2 to 20 wt % lipid (based on the total composition), 3 to 20 wt % wheat flour (based on the total composition), 3 to 30 wt % pulse flour (based on the total composition), and 0.5 to 45 wt % flavor (based on the total composition), wherein the bajra flake and barley flake have a thickness between 0.3 to 1 mm and a length between 2.5 to 15 mm.

In a preferred aspect the present invention pertains to an instant porridge composition comprising 15 to 45 wt % bajra flake (based on the total composition), 8 to 30 wt % barley flake (based on the total composition), 2 to 20 wt % lipid (based on the total composition), 3 to 20 wt % wheat flour (based on the total composition), 3 to 30 wt % pulse flour (based on the total composition), and 0.5 to 45 wt % flavor (based on the total composition), wherein the bajra flake and barley flake have a thickness between 0.3 to 1 mm and a length between 2.5 to 15 mm.

In a preferred aspect the present invention pertains to an instant porridge composition comprising pearl millet flake, barley flake, lipid, enzymatically treated and roller dried wheat flour, pulse flour and flavor, wherein the pearl millet flake and barley flake have a thickness between 0.3 to 1 mm and a length between 2.5 to 15 mm.

In a preferred aspect the present invention pertains to an instant porridge composition comprising bajra flake, barley flake, lipid, enzymatically treated and roller dried wheat flour composition, pulse flour and flavor, wherein the bajra flake and barley flake have a thickness between 0.3 to 1 mm and a length between 2.5 to 15 mm.

In a preferred aspect the present invention pertains to an instant porridge composition comprising 15 to 45 wt % bajra flake (based on the total composition), 8 to 30 wt % barley flake (based on the total composition), 2 to 20 wt % lipid (based on the total composition), 3 to 20 wt % enzymatically treated and roller dried wheat flour composition (based on the total composition), 3 to 30 wt % pulse flour (based on the total composition), and 0.5 to 45 wt % flavor (based on the total composition), wherein the bajra flake and barley flake have a thickness between 0.3 to 1 mm and a length between 2.5 to 15 mm.

In another aspect the present invention pertains to a process for the production of a process for the production of an instant porridge composition comprising grain flake, flour, lipid and flavor, the process comprising the steps of:
a) Melting the lipid;
b) Adding the grain flake to the melted lipid and mix;
c) Roasting the mix from step b) and further mix;
d) Cooling the mixture of step c);
e) Adding the flour and the flavor and further mix to coat the grain flakes from step d) with flour and flavor;
   wherein the grain flake have a thickness between 0.3 to 1 mm.

In a preferred aspect the present invention pertains to a process for the production of a process for the production of an instant porridge composition comprising millet flake, barley flake, flour, lipid and flavor, the process comprising the steps of:
f) Melting the lipid;
g) Adding the millet flake and the barley flake to the melted lipid and mix;
h) Roasting the mix from step b) and further mix;
i) Cooling the mixture of step c);
j) Adding the flour and the flavor and further mix to coat the flakes from step d) with flour and flavor;
   wherein the millet flake and barley flake have a thickness between 0.3 to 1 mm.

In a preferred aspect the present invention pertains to a process for the production of a process for the production of an instant porridge composition comprising millet flake, barley flake, flour, lipid and flavor, the process comprising the steps of:
a) Melting the lipid;
b) Adding the millet flake and the barley flake to the melted lipid and mix;
c) Roasting the mix from step b) and further mix;
d) Cooling the mixture of step c);
e) Adding the flour and the flavor and further mix to coat the flakes from step d) with flour and flavor;
   wherein the millet flake and barley flake have a thickness between 0.3 to 1 mm and a length between 2.5 to 15 mm.

In a preferred aspect the present invention pertains to a process for the production of a process for the production of an instant porridge composition comprising millet flake, barley flake, flour, lipid and flavor, the process comprising the steps of:
a) Melting the lipid;
b) Adding the millet flake and the barley flake to the melted lipid and mix;
c) Roasting the mix from step b) and further mix;
d) Cooling the mixture of step c);
e) Mixing the flour and the flavor and add it to the flakes from step d) by further mixing to coat the flakes from step d) with flour and flavor;
   wherein the millet flake and barley flake have a thickness between 0.3 to 1 mm and a length between 2.5 to 15 mm.

In a preferred aspect the present invention pertains to a process for the production of a process for the production of an instant porridge composition comprising 15 to 45 wt % pearl millet flake (based on the total composition), 8 to 30 wt % barley flake (based on the total composition), 2 to 20 wt % lipid (based on the total composition), 6 to 50 wt % flour (based on the total composition) and 0.5 to 45 wt % flavor (based on the total composition), the process comprising the steps of:
a) Melting the lipid;
b) Adding the pearl millet flake and the barley flake to the melted lipid and mix;
c) Roasting the mix from step b) and further mix;
d) Cooling the mixture of step c);
e) Adding the flour and the flavor and further mix to coat the flakes from step d) with flour and flavor;
   wherein the pearl millet flake and barley flake have a thickness between 0.3 to 1 mm and a length between 2.5 to 15 mm.

In a preferred aspect the present invention pertains to a process for the production of a process for the production of an instant porridge composition comprising 15 to 45 wt % bajra flake (based on the total composition), 8 to 30 wt % barley flake (based on the total composition), 2 to 20 wt % lipid (based on the total composition), 3 to 20 wt % wheat flour (based on the total composition), 3 to 30 wt % pulse flour (based on the total composition), and 0.5 to 45 wt % flavor (based on the total composition), the process comprising the steps of:
a) Melting the lipid;
b) Adding the bajra flake and the barley flake to the melted lipid and mix;
c) Roasting the mix from step b) and further mix;
d) Cooling the mixture of step c);
e) Adding the flour and the flavor and further mix to coat the flakes from step d) with flour and flavor;
   wherein the bajra flake and barley flake have a thickness between 0.3 to 1 mm and a length between 2.5 to 15 mm.

In a preferred aspect the present invention pertains to a process for the production of a process for the production of an instant porridge composition comprising 15 to 45 wt % bajra flake (based on the total composition), 8 to 30 wt % barley flake (based on the total composition), 2 to 20 wt % lipid (based on the total composition), 3 to 20 wt % enzymatically treated and roller dried wheat flour composition (based on the total composition), 3 to 30 wt % pulse flour (based on the total composition), and 0.5 to 45 wt % flavor (based on the total composition), the process comprising the steps of:
a) Melting the lipid;
b) Adding the bajra flake and the barley flake to the melted lipid and mix;
c) Roasting the mix from step b) and further mix;
d) Cooling the mixture of step c);
e) Adding the flour and the flavor and further mix to coat the flakes from step d) with flour and flavor;
   wherein the bajra flake and barley flake have a thickness between 0.3 to 1 mm and a length between 2.5 to 15 mm.

In a preferred aspect the present invention pertains to a process for the production of a process for the production of an instant porridge composition comprising 15 to 45 wt % bajra flake (based on the total composition), 8 to 30 wt % barley flake (based on the total composition), 2 to 20 wt % lipid (based on the total composition), 3 to 20 wt % wheat flour (based on the total composition), 3 to 30 wt % pulse flour (based on the total composition), and 0.5 to 45 wt % flavor (based on the total composition), the process comprising the steps of:
a) Melting the lipid;
b) Adding the bajra flake and the barley flake to the melted lipid and mix between 5 to 50 rpm;
c) Roasting the mix from step b) and further mix;
d) Cooling the mixture of step c);
e) Adding the flour and the flavor and further mix between 10 to 50 rpm to coat the flakes from step d) with flour and flavor;
   wherein the bajra flake and barley flake have a thickness between 0.3 to 1 mm and a length between 2.5 to 15 mm.

In a preferred aspect the present invention pertains to a process for the production of a process for the production of an instant porridge composition comprising 15 to 45 wt % bajra flake (based on the total composition), 8 to 30 wt % barley flake (based on the total composition), 2 to 20 wt % lipid (based on the total composition), 3 to 20 wt % enzymatically treated and roller dried wheat flour composition (based on the total composition), 3 to 30 wt % pulse flour (based on the total composition), and 0.5 to 45 wt % flavor (based on the total composition), the process comprising the steps of:
a) Melting the lipid;
b) Adding the bajra flake and the barley flake to the melted lipid and mix between 5 to 50 rpm;
c) Roasting the mix from step b) and further mixing;
d) Cooling the mixture of step c);
e) Adding the flour and the flavor and further mix between 10 to 50 rpm to coat the flakes from step d) with flour and flavor;
   wherein the bajra flake and barley flake have a thickness between 0.3 to 1 mm and a length between 2.5 to 15 mm.

In a preferred the present invention pertains to a process for the production of a process for the production of an instant porridge composition comprising 15 to 45 wt % bajra flake (based on the total composition), 8 to 30 wt % barley flake (based on the total composition), 2 to 20 wt % lipid (based on the total composition), 3 to 20 wt % enzymatically treated and roller dried wheat flour composition (based on the total composition), 3 to 30 wt % pulse flour (based on the total composition), and 0.5 to 45 wt % flavor (based on the total composition), the process comprising the steps of:
a) Melting the lipid;
b) Adding the bajra flake and the barley flake to the melted lipid and mix between 5 to 50 rpm;
c) Roasting the mix from step b) and further mix;
d) Cooling the mixture of step c);
e) Mixing the flour and the flavor between 50 to 150 rpm and add the flour and flavor mix to the flakes from step d) by further mixing between 10 to 50 rpm to coat the flakes from step d) with flour and flavor;
   wherein the bajra flake and barley flake have a thickness between 0.3 to 1 mm and a length between 2.5 to 15 mm.

The term instant according to this invention means that the porridge has a soaking time of 4 min when hot water or hot milk is added.

The term “grain flake” are a group of small-seeded grasses, widely grown around the world for human food in flake form. The grain flake is selected from the group consisting of wheat flake, barley flake, oat flake, maize flake, rye flake, millet flake or a combination thereof, preferably a combination of millet flake and barley flake. In an embodiment the grain flake is selected from the group consisting of wheat flake (Triticum aestivum), barley flake (Hordeum vulgare), oat flake (Avena sativa), maize flake (Zea mays), rye flake (Secale cereale), millet flake which may include pearl millet or bajra (Pennisetum glaucum), finger millet or ragi (Eleusine coracana), proso millet, or common millet or broomcorn millet or hog millet or white millet or baragu (Panicum miliaceum), little millet or Saamey (Panicum sumatrense), sonoran millet (Panicum sonorum), foxtail millet or Italian millet (Setaria italica), polish millet (Digitaria sanguinalis), Barnyard millet (Echinochloa esculenta), kodo millet (Paspalum scrobiculatum), guinea millet (Brachiaria deflexa), browntop millet (Brachiaria ramosa), Taiwan oil millet (Spodiopogon formosanus), white fonio or fonio millet (Digitaria exilis), black fonio (Digitaria iburua), sorghum (Sorghum bicolor) or a combination thereof, preferably a combination of millet flake and barley flake. In an embodiment of the invention the grain flake has a thickness between 0.3 to 1 mm, preferably between 0.35 to 0.95 mm, preferably between 0.4 to 0.9 mm, preferably between 0.45 to 0.85 mm, more preferably between 0.5 to 0.8 mm. In an embodiment the grain flake has a length between 2.5 to 15 mm, preferably between 3 to 14 mm, preferably between 4 to 13 mm, preferably between 5 to 12 mm, preferably between 5 to 10 mm. In an embodiment the grain flake has a thickness between 0.3 to 1 mm and a length between 2.5 to 15 mm, preferably a thickness between 0.35 to 0.95 mm and a length between 3 to 14 mm, preferably a thickness between 0.4 to 0.9 mm and length between 4 to 13 mm, preferably a thickness between 0.45 to 0.85 mm and length between 5 to 12 mm, more preferably a thickness between 0.5 to 0.8 mm and length between 5 to 12 mm.

In an embodiment the instant porridge composition comprises 15 to 70 wt % of grain flake (by weight of the total composition), preferably 15 to 60 wt %, preferable 15 to 55 wt %, preferably 15 to 50 wt %, preferably 20 to 60 wt %, preferably 20 to 55 wt %, preferable 20 to 50 wt %, preferably 25 to 60 wt %, preferably 25 to 55 wt %, preferably 25 to 50 wt %, preferable 30 to 60 wt %, preferably 30 to 55 wt %, preferably 30 to 50 wt % (by weight of the total composition).

The millets are selected from the group of millet flake which may include pearl millet or bajra (Pennisetum glaucum), finger millet or raji (Eleusine coracana), proso millet, or common millet or broomcorn millet or hog millet or white millet or baragu (Panicum miliaceum), little millet or Saamey (Panicum sumatrense), sonoran millet (Panicum sonorum), foxtail millet or Italian millet (Setaria italica), polish millet (Digitaria sanguinalis), Barnyard millet (Echinochloa esculenta), kodo millet (Paspalum scrobiculatum), guinea millet (Brachiaria deflexa), browntop millet (Brachiaria ramosa), Taiwan oil millet (Spodiopogon formosanus), white fonio or fonio millet (Digitaria exilis), black fonio (Digitaria iburua), sorghum (Sorghum bicolor). In an embodiment of the invention the millet flake has a thickness between 0.3 to 1 mm, preferably between 0.35 to 0.95 mm, preferably between 0.4 to 0.9 mm, preferably between 0.45 to 0.85 mm, more preferably between 0.5 to 0.8 mm. In an embodiment the millet flake has a length between 2.5 to 15 mm, preferably between 3 to 14 mm, preferably between 4 to 13 mm, preferably between 5 to 12 mm, preferably between 5 to 10 mm. In an embodiment the millet flake has a thickness between 0.3 to 1 mm and a length between 2.5 to 15 mm, preferably a thickness between 0.35 to 0.95 mm and a length between 3 to 14 mm, preferably a thickness between 0.4 to 0.9 mm and length between 4 to 13 mm, preferably a thickness between 0.45 to 0.85 mm and length between 5 to 12 mm, more preferably a thickness between 0.5 to 0.8 mm and length between 5 to 12 mm. In an embodiment the instant porridge composition comprises 15 to 45 wt % of millet flake (by weight of the total composition), preferable 15 to 40 wt %, preferably 18 to 45 wt %, preferably 18 to 40 wt % (by weight of the total composition). In an embodiment the instant porridge composition comprises 15 to 45 wt % of pearl millet flake (by weight of the total composition), preferable 15 to 40 wt %, preferably 18 to 45 wt %, preferably 18 to 40 wt % (by weight of the total composition). In an embodiment the instant porridge composition comprises 15 to 45 wt % of bajra flake (by weight of the total composition), preferable 15 to 40 wt %, preferably 18 to 45 wt %, preferably 18 to 40 wt % (by weight of the total composition).

The term “barley flake” (Hordeum vulgare) is a member of a grass family which is in flake form. In an embodiment of the invention the barley flake has a thickness between 0.3 to 1 mm, preferably between 0.35 to 0.95 mm, preferably between 0.4 to 0.9 mm, preferably between 0.45 to 0.85 mm, more preferably between 0.5 to 0.8 mm. In an embodiment the barley flake has a length between 2.5 to 15 mm, preferably between 3 to 14 mm, preferably between 4 to 13 mm, preferably between 5 to 12 mm, preferably between 5 to 10 mm. In an embodiment the barley flake has a thickness between 0.3 to 1 mm and a length between 2.5 to 15 mm, preferably a thickness between 0.35 to 0.95 mm and a length between 3 to 14 mm, preferably a thickness between 0.4 to 0.9 mm and length between 4 to 13 mm, preferably a thickness between 0.45 to 0.85 mm and length between 5 to 12 mm, more preferably a thickness between 0.5 to 0.8 mm and length between 5 to 12 mm. In an embodiment the instant porridge composition comprises 8 to 30 wt % of barley flake (by weight of the total composition), preferable 8 to 27 wt %, preferably 8 to 25 wt %, preferably 10 to 30 wt %, preferably 10 to 27 wt %, preferable 10 to 25 wt % (by weight of the total composition).

Thickness and length of the flakes were measured by standard method using a caliper (micrometre) for measuring the length, width, and thickness of flaked grains and product containing it.

The term “flour” according to this invention means at least one ingredient of wheat flour, oat flour, corn flour, rice flour, barley flour, millet flour, pulse flour or combinations thereof, preferably a combination of wheat flour and pulse flour, more preferably a combination of wheat flour and moong bean flour. In a preferred embodiment the wheat flour is an enzymatically treated and roller dried wheat flour composition. In an embodiment the instant porridge composition comprises 6 to 50 wt % of flour (by weight of the total composition), preferable 6 to 45 wt %, preferably 6 to 40 wt %, preferably 6 to 35 wt %, preferably 6 to 30 wt %, preferable 10 to 50 wt %, preferably 10 to 45 wt %, preferably 10 to 40 wt %, preferably 10 to 35 wt %, preferable 15 to 50 wt %, preferably 15 to 45 wt %, preferably 15 to 40 wt %, preferably 15 to 35 wt %, preferably 10 to 30 wt %, preferably 15 to 30 wt % (by weight of the total composition). In an embodiment the instant porridge comprises 3 to 20 wt % wheat flour (based on the total composition) and 3 to 30 wt % pulse flour (based on the total composition), preferably 3 to 20 wt % wheat flour (based on the total composition) and 3 to 30 wt % moong bean flour (based on the total composition), preferably 3 to 20 wt % enzymatically treated and roller dried wheat flour composition (based on the total composition) and 3 to 30 wt % moong bean flour (based on the total composition),

The term “enzymatically treated and roller dried wheat flour” describe a wheat flour composition which is obtained according to WO2018/011400. WO2018/011400 describes the preparation of a slurry comprising 70 to 80 wt % wheat flour (dry weight of slurry), 7 to 16 wt % sugar (dry weight of slurry), 2 to 10 wt % soybean oil (dry weight of slurry), 3 to 8 wt % skimmed milk powder (dry weight of slurry) and water, Heating the slurry to a temperature between 60-78° C., addition of heat stable starch degrading hydrolytic enzyme and mixing for 10-20 minutes, Inactivation of the enzyme & drying to 2-6% final moisture content through roller drying, cooling & breaking into fine granulated form. As compared to regular wheat flour the enzymatically treated and roller dried wheat flour is easy to disperse and hydrate, quick flowable consistency development, no set back/jelling/lumping on cooling, golden brown colour, pleasant aroma and high shelf life.

In an embodiment the instant porridge composition comprises a protein content between 6 to 20%, preferably between 6 to 18%, preferably between 6.5 to 17%, preferably between 7 to 15%.

The term “lipid” according to this invention means an oil, fat or a combination thereof, preferably a combination of fat and oil. In an embodiment the oil is selected from the group consisting of sunflower oil (SO), high oleic sunflower oil (HOSO), corn oil, cottonseed oil, mango kernel oil, rapeseed oil, rice bran oil, soybean oil, palm oil, canola oil, ground nut oil or a combination thereof, preferably sunflower oil, high oleic sunflower oil or a combination thereof. In an embodiment the lipid of this invention has a congealing point of 10 to 60° C., preferably has a congealing point of 20 to 60° C., preferably has a congealing point of 30 to 60° C., preferably has a congealing point of 40 to 60° C. It is preferred that the lipid is solid at room temperature (20° C.). In an embodiment the fat is selected from the group consisting of fully and/or partially hydrogenated vegetable fat, clarified or non-clarified butter. In a preferred embodiment the fully and/or partially hydrogenated vegetable fat is palm fat. In a preferred embodiment the clarified butter is ghee. In an embodiment the instant porridge has an amount of lipid in the range of 1 to 20 wt % (by weight of the total composition), preferably between 1 to 15 wt %, preferably between 2 to 20 wt %, preferably between 2 to 15 wt %, preferably between 2 to 13 wt % (by weight of the total composition).

The term “flavor” according to this invention means ingredients selected from the group consisting of salt, sugar, vinegar, yeast extract, vegetable powder, bacterial extract, vegetable extract, reaction flavour, hydrolysed plant protein, acid, garnishes, herbs, spices or combinations of these. The formed product according to the invention comprise between 0.5 to 45 wt % flavor, preferably 3 to 45 wt %, preferably 3 to 40 wt %, preferably 5 to 40 wt % (by weight of the composition). Vegetable powder means at least one ingredient of onion powder, garlic powder, tomato powder, celery root powder or a combination thereof. Garnishes, herbs, spices or a combination thereof are selected from the group comprising pieces of parsley, celery, fenugreek, lovage, rosemary, marjoram, dill, tarragon, coriander, ginger, lemongrass, curcuma, chili, ginger, paprika, mustard, garlic, onion, turmeric, tomato, coconut milk, oregano, thyme, basil, chillies, green chillies, paprika, pimento, jalapeno pepper, white pepper powder and black pepper or combinations of these.

Roasting is a process wherein raw taste is eliminated and characteristic roasted/fried flavor is generated in the end product. The roasting with lipid is done between a temperature range of 50-130° C. for 5 to 95 min, preferably between a temperature range of 85 to 120° C. for 10 to 40 min, preferably between a temperature range of 95 to 120° C. for 15 to 30 min, preferably between a temperature range of 100 to 120° C. for 15 to 20 min, preferably between a temperature range of 70 to 80° C. for 5 to 25 min, preferably between a temperature range of 72 to 90° C. for 10 to 20 min.

Cooling means that the temperature is reduced. It is desirable to have a temperature the same as or close to room temperature before wrapping, preferably between 20 to 40° C., preferably between 25 to 35° C., preferably between 20 to 30° C., more preferably between 20 to 25° C. Otherwise, there may be condensation of water vapour in the packet of porridge, which may lead to mould growth.

Those skilled in the art will understand that they can freely combine all features of the present invention disclosed herein. In particular, features described for different embodiments of the present invention may be combined. Where known equivalents exist to specific features, such equivalents are incorporated as if specifically referred to in this specification.

### EXAMPLES

### Example 1: Process

The lipid is heated in a roasting/sauteing vessel at a temperature of 80° C. The millet flakes and barley flakes are added and roasted at a temperature of 75° C. for 3-5 min. Afterwards the coated and roasted flakes are cooled to a temperature between 30 to 35° C. Flour and flavor are added and the mass and mixed for at least 2 min at ambient conditions until the flour and flavor are coating the flakes properly.

### Examples 2-8

Examples 2 to 8 are prepared according to example 1.

| | Ex. 2 | Ex. 3 | Ex. 4 | Ex. 5 | Ex 6 |
|---|---|---|---|---|---|
| Bajra flakes [wt %] having a | 22 | 38 | 21 | 38 | — |
| thickness between 0.5 to | | | | | |
| 0.8 mm and a length | | | | | |
| between 5 to 10 mm | | | | | |
| Pearled barley flakes [wt %] | 14 | 13 | 22 | 13 | |
| having a thickness between | | | | | |
| 0.5 to 0.8 mm and a length | | | | | |
| between 5 to 10 mm | | | | | |
| Oak flakes having a | — | — | — | — | 50 |
| thickness between 0.5 to | | | | | |
| 0.8 mm and a length | | | | | |
| between 5 to 10 mm | | | | | |
| Wheat flour (enzymatically | 12 | 8 | 15 | — | 10 |
| treated and roller dried) | | | | | |
| Wheat flour | — | — | — | 8 | — |
| Moong bean flour | 10 | 20 | 24 | 20 | 20 |
| Flavor (sugar and/or salt | 37 | 9 | 13 | 9 | 10 |
| and/or spices) | | | | | |
| Lipid [wt %] | 5 | 12 | 5 | 12 | 10 |

Sensory

| | | | | | |
|---|---|---|---|---|---|
| *Sensory data of solubility | 5 | 5 | 5 | 3 | 5 |
| 4 min after adding hot water | | | | | |
| *Sensory data of texture | 5 | 5 | 5 | 3 | 3 |
| 4 min after adding hot water | | | | | |
| Mouthfeel | 5 Soft & | 4 Soft & | 5 Soft & | 3 Thick & | 3 Thick & |
| | pulpy, | pulpy, | Pulpy, | pasty | pasty |
| | creamy | creamy | creamy | mouthfeel | mouthfeel |
| | mouthfeel | mouthfeel | mouthfeel | | |
| Appearance | 5 Lump | 5 Lump | 5 Lump | 3 Lumpy | 3.5 Lumpy |
| | free | free | free | | |
| Spoon ability | Non sticky | Non sticky | Non sticky | sticky | sticky |
| Protein content [%] | 7.3 | 10.9 | 12 | 10.4 | 10.8 |

*0- lowest score, 5- highest score; 20 panellists tested.

| | Comp. Ex. 7 | Comp. Ex. 8 |
|---|---|---|
| Bajra flakes [wt %] having a | 38 | — |
| thickness between 0.1 to 0.2 | | |
| mm and a length between 5 to | | |
| 10 mm | | |
| Pearled barley flakes [wt %] | 13 | — |
| having a thickness between | | |
| 0.1 to 0.2 mm and a length | | |
| between 5 to 10 mm | | |
| Bajra flakes [wt %] having a | — | 38 |
| thickness between 1.1 to 1.3 | | |
| mm and a length between 5 to | | |
| 10 mm | | |
| Pearled barley flakes [wt %] | — | 13 |
| having a thickness between | | |
| 1.1 to 1.3 mm and a length | | |
| between 5 to 10 mm | | |
| Wheat flour (enzymatically | 8 | 8 |
| treated and roller dried) | | |
| Moong bean flour | 20 | 20 |
| Flavor (sugar and/or salt | 9 | 9 |
| and/or spices) | | |
| Lipid (ghee) [wt %] | 12 | 12 |

Sensory

| | | |
|---|---|---|
| *Sensory data of solubility | 5 | 0 |
| 4 min after adding hot water | | |
| *Sensory data of texture 4 min | 0 | 3 |
| after adding hot water | | |
| Mouthfeel | 1 pasty | 1 Not |
| | | swell |
| | | properly |
| Appearance | 2 | 2 |
| Spoon ability | sticky | Non sticky |
| | | and flowable |
| Protein content % | 10.9% | 10.9 |

*0- lowest score, 5- highest score; 20 panellists tested.

The best porridges compositions are achieved within examples 2 to 6, wherein the flakes have a thickness between 0.5 to 0.8 mm and a length between 5 to 10 mm. In case the flakes have a lower thickness as shown in comp. ex. 7 the solubility is very high, but the texture of the porridge is very pasty. In case the flakes have a higher thickness as shown in comp. ex. 8 the solubility is low, and the flakes does not swell and cook properly within 4 min.

### Comparison Example 9

Comparison example 9 is prepared according to example 1, but no flour is added to the composition.

| | Com. Ex. 9 |
|---|---|
| Bajra flakes [wt %] having a | 40 |
| thickness between 0.5 to 0.8 | |
| mm and a length between 5 to | |
| 10 mm | |
| Pearled barley flakes [wt %] | 25 |
| having a thickness between 0.5 | |
| to 0.8 mm and a length between | |
| 5 to 10 mm | |
| Oak flakes having a thickness | — |
| between 0.5 to 0.8 mm and a | |
| length between 5 to 10 mm | |
| Wheat flour (enzymatically | — |
| treated and roller dried) | |
| Wheat flour | — |
| Moong bean flour | — |
| Flavor (sugar and/or salt and/or | 25 |
| spices) | |
| Lipid [wt %] | 10 |

Sensory

| | |
|---|---|
| *Sensory data of solubility 4 min | 5 |
| after adding hot water | |
| *Sensory data of texture 4 min | 2 |
| after adding hot water | |
| Mouthfeel | 2 grainy |
| | mouthfeel |
| Appearance | 2 Mushy |
| | & soggy |
| Spoon ability | Sticky |
| Protein content [%] | 5.6 |

The obtained porridge has a good solubility, but the texture, mouthfeel and appearance are rated with lower scores compared to examples 2 to 6.

1. An instant porridge composition comprising grain flake, lipid, flour and flavor, wherein the grain flake has a thickness between 0.3 to 1 mm.

2. An instant porridge composition as claimed in claim 1, wherein the weight of the grain flake is 15 to 70 wt % by weight of the total composition.

3. An instant porridge composition of claim 1, wherein the grain flake has a length between 2.5 to 15 mm.

4. An instant porridge composition of claim 1, wherein the grain flake is selected from the group consisting of wheat flake, barley flake, oat flake, maize flake, rye flake, Sorghum flake, millet flake and a combination thereof.

5. An instant porridge composition of claim 1, wherein the grain flake is a combination of a millet flake and a barley flake.

6. An instant porridge composition of claim 1, wherein the grain flake is a combination of 15 to 45 wt % millet flake (based on the total composition) and 8 to 30 wt % barley flake (based on the total composition).

7. An instant porridge composition as claimed in claim 1, wherein the flour is selected from the group consisting of wheat flour, oat flour, corn flour, rice flour, barley flour, millet flour, pulse flour and combinations thereof.

8. An instant porridge composition as claimed in claim 1, wherein the flour is a combination of wheat flour and moong bean flour.

9. An instant porridge composition as claimed in claim 1, wherein the weight of the flour is in the range of 5 to 50 wt % (by weight of the total composition).

10. An instant porridge composition as claimed in claim 1, wherein the weight of the flavor is in the range of 0.5 to 45 wt % (by weight of the total composition).

11. An instant porridge composition as claimed in claim 1, wherein the weight of the lipid is in the range of 2 to 20 wt % (by weight of the total composition).

12. A process for the production of an instant porridge composition comprising grain flake, flour, lipid and flavor, the process comprising the steps of:
a) Melting the lipid;
b) Adding the grain flake to the melted lipid and mix;
c) Roasting the mix from step b) and further mixing;
d) Cooling the mixture of step c); and
e) Adding the flour and the flavor and mix to coat the grain flakes from step d);
wherein the grain flake have a thickness between 0.3 to 1 mm.

13. A process for the production of an instant porridge composition as claimed in claim 12, wherein the roasting is done at a temperature between 50 to 130° C. for 5 to 95 min.

14. (canceled)
